(19) United States
(12) Patent Application Publication
(10) Pub. No.: US 2018/0178464 A1
(43) Pub. Date: Jun. 28, 2018

(54) METHOD OF PRODUCING MOLDING PRODUCT, MOLDING TOOL, AND METHOD OF PRODUCING MOLDING PRODUCT USING THE MOLDING TOOL

(71) Applicant: TOYOTA BOSHOKU KABUSHIKI KAISHA, Aichi (JP)

(72) Inventors: Itsuki TSUDA, Aichi-ken (JP); Keisuke KURODA, Aichi-ken (JP); Takashi KURIKI, Aichi-ken (JP)

(73) Assignee: TOYOTA BOSHOKU KABUSHIKI KAISHA, Aichi (JP)

(21) Appl. No.: 15/847,180

(22) Filed: Dec. 19, 2017

(30) Foreign Application Priority Data
Dec. 22, 2016 (JP) 2016-248921

(51) Int. Cl. B29C 71/00; B29C 45/00; B29C 45/26; B29C 45/73

(52) U.S. Cl. CPC B29C 71/009; B29C 45/73; B29C 45/26; B29C 45/0053

(57) ABSTRACT

A method of producing a molding product including a non-design surface and a design surface including a leather textured surface and adjacent to the non-design surface includes: injecting molten plastic into a forming cavity of a molding tool including a first forming surface to form the non-design surface and a second forming surface to form the design surface; and blowing air toward a boundary between the non-design surface and the first forming surface until a gap is created between the non-design surface and the first forming surface and toward a boundary between the design surface and the second forming surface via a hole formed in the first forming surface until a gap is created between the design surface and the second forming surface after the injecting of the molten plastic.

### CROSS REFERENCE TO RELATED APPLICATION

This application claims priority from Japanese Patent Application No. 2016-248921 filed on Dec. 22, 2016. The entire contents of the priority application are incorporated herein by reference.

### TECHNICAL FIELD

The present disclosure relates to a method of producing a molding product, a molding tool, and a method of producing a molding product using the molding tool.

### BACKGROUND

An example of a method for forming a molding product includes forming an embossing pattern on a surface of a molding and transferring the embossing pattern to a surface of the molding product to form a design surface including a leather textured surface.

In a production of the molding product including the design surface, the forming surface of the molding may rub the design surface resulting in scratches on the design surface which may create a blur on the design surface.

### SUMMARY

The present invention was made in view of the foregoing circumstances. An object is to provide a method of producing a molding product including a leather textured design surface without rubbing of a forming surface against the design surface.

A method of producing a molding product including a non-design surface and a design surface including a leather textured surface and adjacent to the non-design surface includes: injecting molten plastic into a forming cavity of a molding tool including a first forming surface to form the non-design surface and a second forming surface to form the design surface; and blowing air toward a boundary between the non-design surface and the first forming surface until a gap is created between the non-design surface and the first forming surface and toward a boundary between the design surface and the second forming surface via a hole formed in the first forming surface until a gap is created between the design surface and the second forming surface after the injecting of the molten plastic.

According to the technology disclosed herein, a method of producing a molding product including a design surface including a leather textured surface without rubbing between the design surface and a forming surface is provided.

### BRIEF DESCRIPTION OF THE DRAWINGS

FIG. 1 is a perspective view illustrating a door trim according to an embodiment.

FIG. 2 is a cross-sectional view illustrating a portion of the door trim in FIG. 1 including an armrest.

FIG. 3 is a cross-sectional view illustrating a forming device for forming a lower board.

FIG. 4 is a magnified view illustrating a portion of the forming device in FIG. 3 including a forming surface for forming a non-design surface.

FIG. 5 is a perspective view illustrating an air channel component defining a hole.

FIG. 6 is a cross-sectional view illustrating a forming surface for forming a design surface of the lower board.

FIG. 7 is a cross-sectional view illustrating a blowing process.

### DETAILED DESCRIPTION

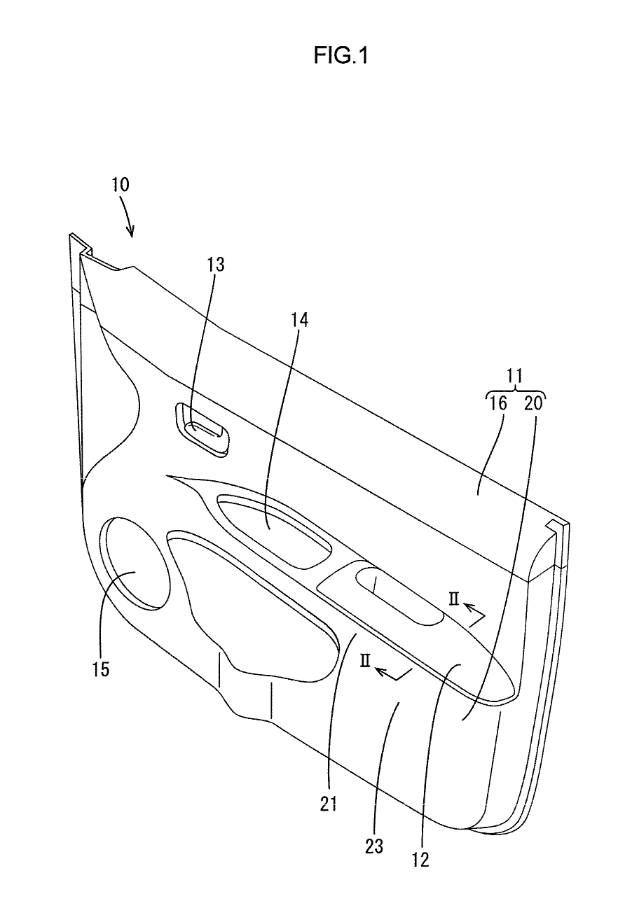

An embodiment will be described with reference to FIGS. 1 to 7. A lower board 20 including in a door trim 10 for a vehicle (a conveyance interior assembly) will be described as an example of a molding product. The door trim 10 is a part of a side door of a vehicle and fixed to a door inner panel with clips from the interior side of the vehicle. The door trim 10 is made of synthetic resin. As illustrated in FIG. 1, the door trim 10 includes a trim board 11 that includes an armrest 12, an inside door handle 13, a switch base, and a speaker grille 15.

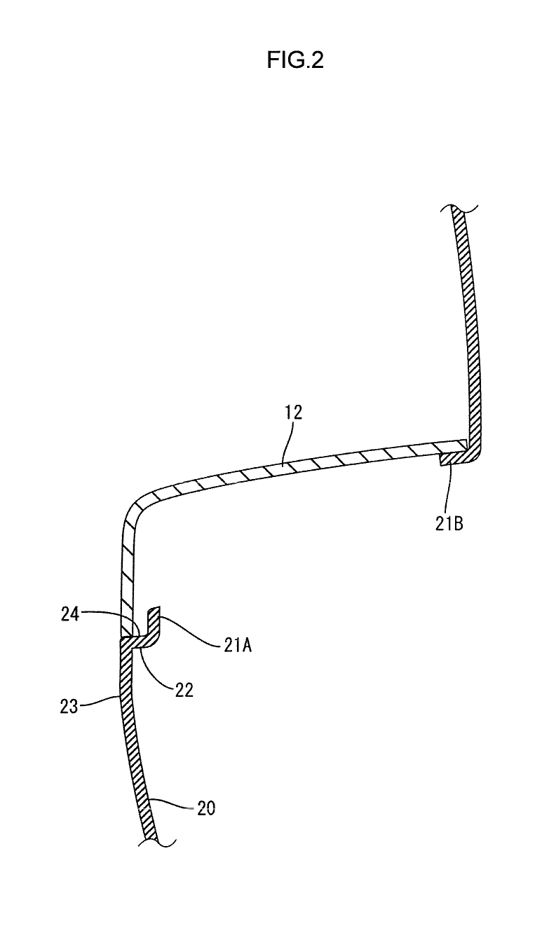

The trim board 11 is made of thermosetting resin (e.g., polypropylene). The trim board 11 includes an upper board 16 and the lower board 20. The upper board 16 forms an upper section of the trim board 11. The lower board 20 forms the most of the rest of sections of the trim board 11. At the middle of the lower board 20 in the vertical direction, a step 21 that project more to the interior side of the vehicle in comparison to the upper section of the trim board 11 is provided. As illustrated in FIG. 2, an upper wall of the step 21 includes a hole 21A for mounting the armrest 12.

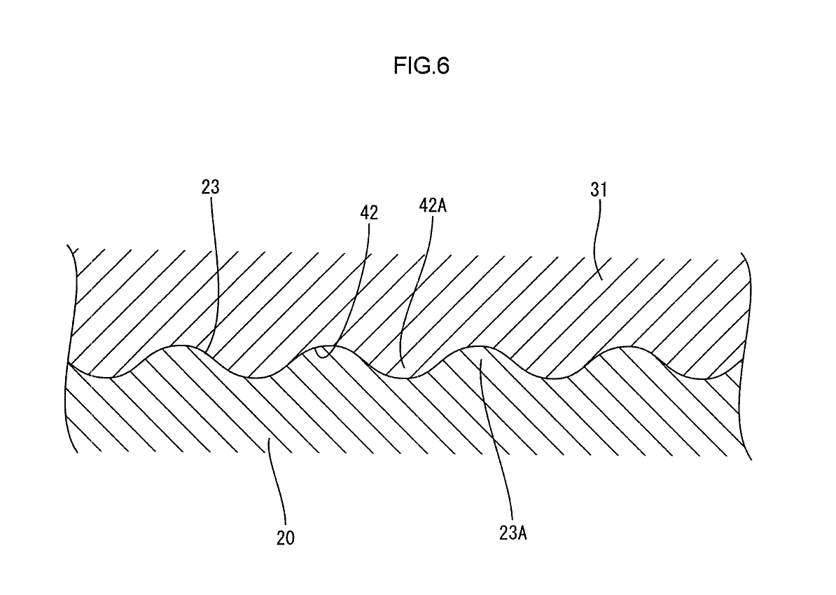

The hole 21A has an elongated shape that extends in the front-rear direction of the vehicle (an extending direction of the armrest 12). As illustrated in FIG. 2, the armrest 12 is supported by hole edges 21B of the hole 21A in the lower board 20 and mounted to the lower board 20. The hole edge 21B on the inner side of the vehicle among the hole edges 21B includes a hold 22 on which an edge of the armrest 12 on the inner side of the vehicle is disposed. A surface of the lower board 20 on the inner side of the vehicle is a design surface 23 that is viewable by an occupant of the vehicle from the inner side of the vehicle. An upper surface of the hold 22 is covered with the armrest 12, that is, a non-design surface 24 (a surface that is not viewable by the occupant). The non-design surface 24 is adjacent to the design surface 23. As illustrated in FIG. 6, an irregular pattern 23A is formed on the design surface 23 of the lower board 20 to create a leather textured surface.

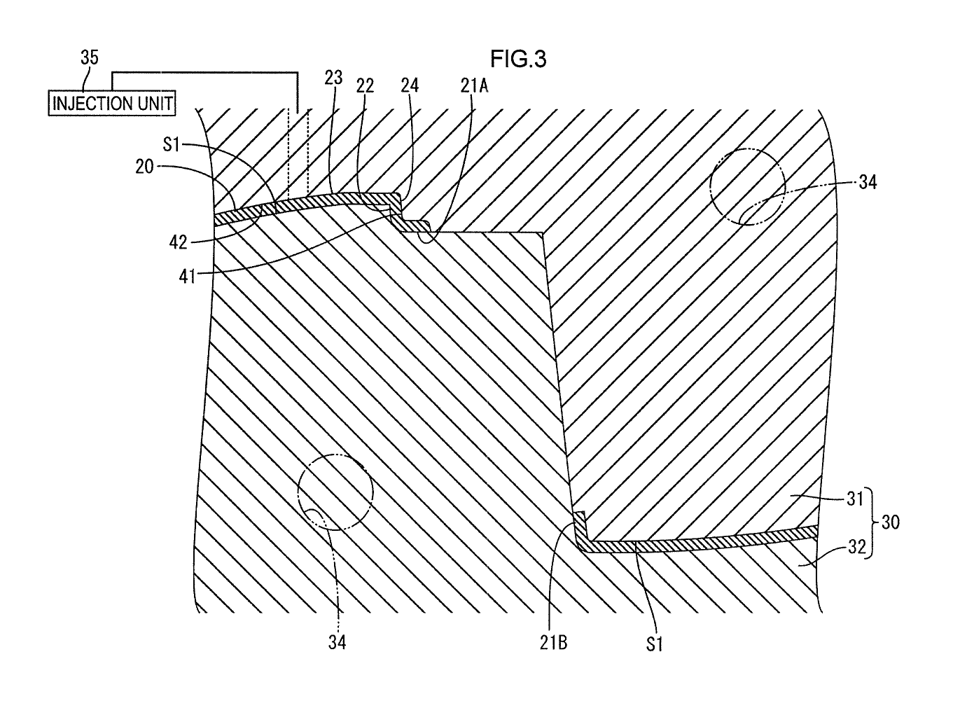

The trim board 11 is produced using a molding tool 30 illustrated in FIG. 3. The molding tool 30 includes a cavity die 31 (a first die), a core die 32 (a second die), and an injection unit 35. The cavity die 31 includes cavities into which molten resin is injected and a cooling water canal 34. The injection unit 35 is a screw-type injection unit that is connected to the cavity die 31. The core die 32 is a movable die that can be moved relative to the cavity die 31 by a drive unit, which may include an electric motor, an air cylinder, and a hydraulic cylinder. The core die 32 is moved toward the cavity die 31 to close the molding tool 30 and away from the cavity die 31 to open the molding tool 30. When the molding tool 30 is closed, a forming cavity S1 is provided. The molten plastic is injected into the forming cavity S1 by the injection unit 35. The core die 32 includes a cooling water canal 34.

The forming cavity S1 has a shape corresponding to a contour of the lower board 20. The cavity die 31 includes a first forming surface 41 and a second forming surface 42. The first forming surface 41 is for forming the non-design surface 24. The second forming surface 42 is for forming the design surface 23. As illustrated in FIG. 6, the second forming surface 42 includes an irregular pattern 42A. The irregular pattern 42A of the second forming surface 42 is transferred to the design surface 23 so that the design surface 23 includes the leather textured surface (the irregular pattern 23A).

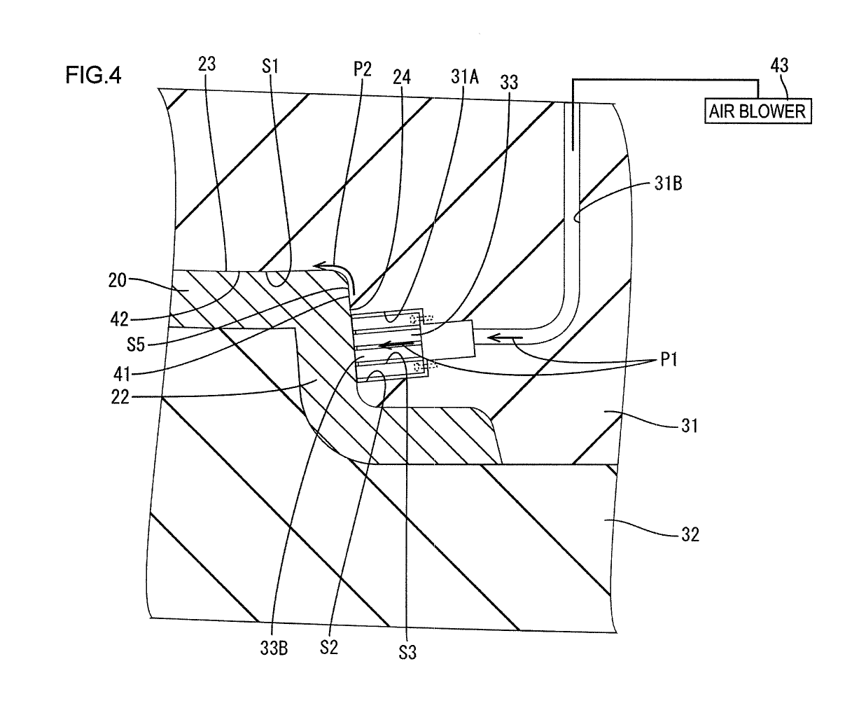

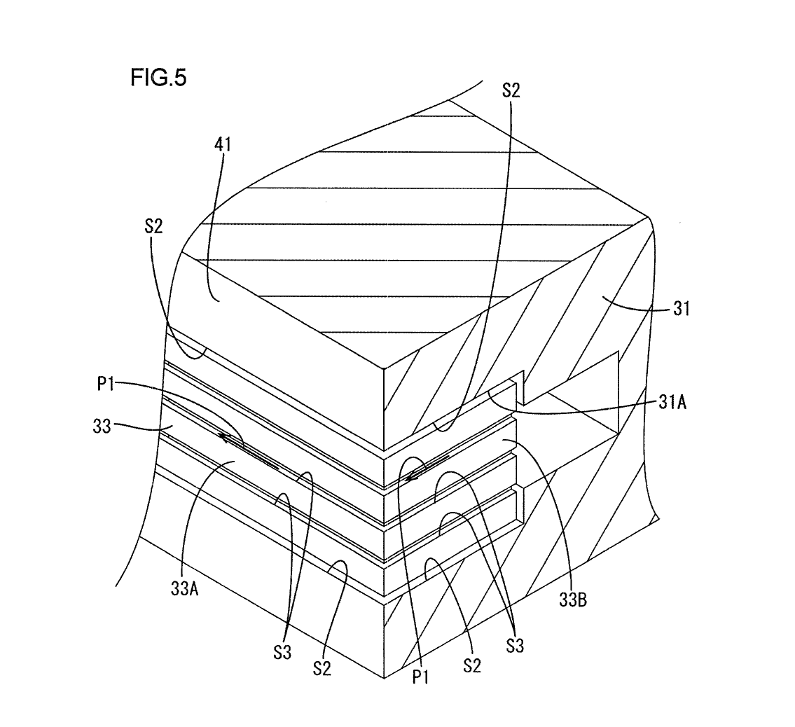

As illustrated in FIGS. 4 and 5, the cavity die 31 includes a recess 31A with an opening facing a section of the forming cavity SI for forming the non-design surface 24. An air channel component 33 is disposed in the recess 31A away from inner walls of the recess 31A to form spaces S2 between surfaces of the air channel component 33 and the inner walls of the recess 31A. The air channel component 33 includes grooves S3 in the outer surfaces.

The air channel component 33 has a cuboidal shape with a long dimension along a long dimension of the hold 22 (corresponding to a long dimension of the armrest 12), that is, the air channel component 33 extends in the direction in which the hold 22 extends (corresponding to the direction in which the armrest 12 extends). A side surface 33A of the air channel component 33 facing the forming cavity S1 is a section of the first forming surface 41. The grooves S3 are continuously formed in end surfaces 33B of the air channel component 33 at ends of the long dimension and the surface 33A of the air channel component 33.

The cavity die 31 includes an air canal 31B connected to a hole in the bottom wall of the recess 31A. The air canal 31B is connected to an air blower 43 (e.g., an air compressor). Sections of the grooves S3 in the side surface 33A extend in the longitudinal direction of the air channel component 33 corresponding to the extending direction in which the hold 22 extends. Sections of the grooves S3 in the end surfaces 33B extend from the air canal 31B side toward the forming cavity S1. The spaces S2 are defined by side surfaces and the end surfaces 33B of the air channel component 33 and the inner walls of the recess 31A including the bottom wall.

The air blower 43 blows air into the spaces S2 and the grooves S3 by via the air canal 31B. The air blow continues into the forming cavity S1. The width of the grooves S3 is set at a size such that the molten plastic does not flow into the grooves S3 (e.g., 0.03 mm). A distance between the adjacent grooves S3 may be set but not limited to 10 mm.

Next, the method of producing the lower board 20 will be described. The method includes an injection step, a dwelling step, a cooling step, and a blowing step.

Injection Step

As illustrated in FIG. 3, the injection unit 35 injects the molten plastic into the forming cavity S1 defined by the cavity die 31 and the core die 32 until the forming cavity S1 is filled with the molten plastic.

Dwelling Step

The dwelling step is preformed after the injection step. While the cavity die 31 and the core die 32 are held together with a force to close the molding tool 30, the injection unit 35 continues injecting the molten plastic into the forming cavity S1 after the forming cavity S1 is filled with the molten plastic in the injection step. A predefined pressure is applied to the molten plastic in the forming cavity S1 for a predefined period (e.g., a few seconds).

Cooling Step

The cooling step is performed after the dwelling step. Cooling water is passed through the cooling water canal 34 in the cavity die 31 and the core die 32 after the injection of the molten plastic by the injection unit 35 is stopped to cool down the cavity die 31 and the core die 32 for a predefined period (e.g., a few times longer than the period of the dwelling step). As a result, the molten plastic in the forming cavity S1 is cooled down and solidified, and the lower board 20 is formed. Then, the core die 32 is moved to open the cavity die 31 to remove the lower board 20. Air or oil may be used instead of the cooling water to cool down the molten plastic in the cooling step.

Blowing Step

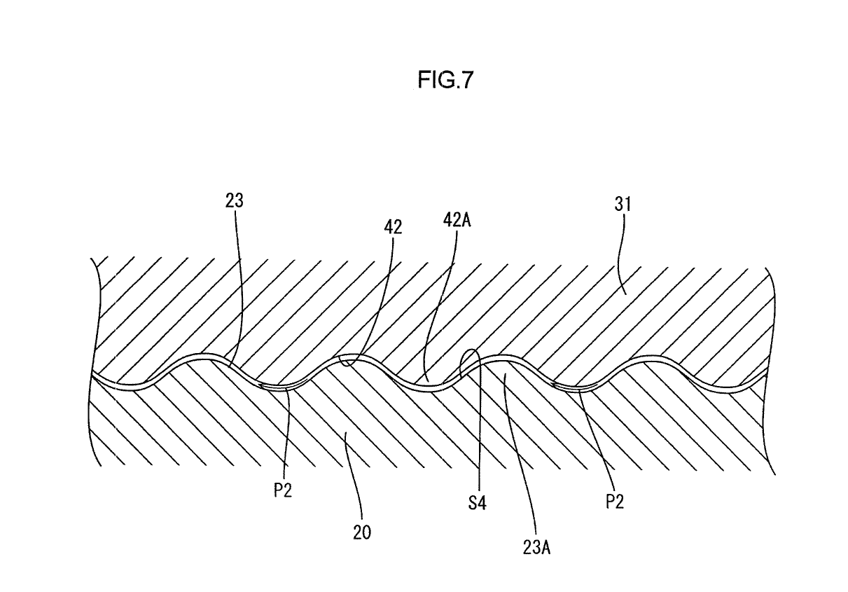

The blowing step is performed after the dwelling step is completed and before the cooling step is completed. The air blower 43 blows air into the spaces S2 and the grooves S3 via the air canal 31B in directions indicated by arrows P1 in FIG. 4. The air is farther blown into the forming cavity S1. A jet of air creates a small gap S5 between the first forming surface 41 and the non-design surface 24. The air is farther blown forward and the jet of air creates a small gap S4 between the design surface 23 and the second forming surface 42 as indicated by arrows P2 in FIGS. 4 and 7. Namely, the design surface 23 is separated from the second forming surface 42 as illustrated in FIG. 7. The blowing step may be started a few second (e.g., 5 seconds) from the completion of the dwelling step.

Next, effects will be described. Because the jet of air creates the small gap S4 between the design surface 23 and the second forming surface 42, the design surface 23 is less likely to rub against the second forming surface 42 even if the lower board 20 contracts in a direction along the design surface 23 (the horizontal direction in FIG. 7) in the cooling step. Therefore, the design surface 23 is less likely to be scratched by the irregular pattern 42A of the second forming surface 42 and become blurry. Furthermore, the spaces S2 and the grooves S3 for feeding the air are formed in the first forming surface 41 that is for forming the non-design surface 24. Marks of opening edges of the space S2 and the grooves S3 may be formed on the non-design surface 24 and thus do not affect the appearance of the design surface 23.

The blowing step is performed after the completion of the dwelling step and before the completion of the cooling step. Namely, the air can be blown toward the boundary between the design surface 23 and the second forming surface 42 before the lower board 20 is completely cooled down. Therefore, the jet of the air that reaches the boundary between the design surface 23 and the second forming surface 42 via the air canal 31B and the gap S5 between the first forming surface 41 and the non-design surface 24 created by the jet of air can create the gap S4 S5 between the first forming surface 41 and the non-design surface 24.

### Other Embodiments

The technology described herein is not limited to the embodiment described in the above description and the drawings. The technology described herein may include the following embodiments.

(1) Molding products including design surfaces with leather textured patterns may be included in the technical scope of the present invention.

(2) The blowing step may be performed in parallel to the dwelling step. If the start of the blowing step is too early, the design surface may be concaved due to the blowing of the air. Therefore, it is preferable to start the blowing step after the design surface is and therearound are formed to an extent but before the molten plastic is completely solidified, that is, it is preferable to star the blowing step in parallel to the cooling step.

(3) The technical scope of the present invention can be applied to non-design surfaces covered with components other than the armrest (e.g., a switch base).

1. A method of producing a molding product including a non-design surface and a design surface including a leather textured surface and adjacent to the non-design surface, the method comprising:
injecting molten plastic into a forming cavity of a molding tool including a first forming surface to form the non-design surface and a second forming surface to form the design surface; and
blowing air toward a boundary between the non-design surface and the first forming surface until a gap is created between the non-design surface and the first forming surface and toward a boundary between the design surface and the second forming surface via a hole formed in the first forming surface until a gap is created between the design surface and the second forming surface after the injecting of the molten plastic.

2. The method according to claim 1, further comprising:
applying a predefined pressure to the molten plastic in the forming cavity after the injecting of the molten plastic; and
cooling down the molten plastic in the forming cavity after the applying of the predefined pressure, wherein
the blowing of the air is started after completion of the applying of the predefined pressure and before completion of the cooling down of the molten plastic.

3. The method according to claim 2, wherein the blowing of the air is started after the design surface is formed to an extent but before the molten plastic is completely solidified.

4. A molding tool for producing a molding product comprising:
a first die including:
a first forming surface to form a non-design surface of the molding product;
a second forming surface to form a design surface of the molding product adjacent to the first forming surface;
a cavity defined by at least the first forming surface and the second forming surface;
a recess with an opening in the first forming surface;
an air channel component disposed in the recess to be separated from an inner wall of the recess and including at least one groove formed in at least a surface to form a section of the non-design surface of the molding product, the at least one groove extending from one end of the surface to another end of the surface;
an air canal including a first end connected to an external air blower and a second end connected to the recess; and
a second die configured to be movable toward and away from the first die, the second die including:
a first surface opposed to the first forming surface; and
a second surface opposed to the second forming surface, wherein
the first forming surface, the first surface, the second forming surface, and the second surface define a forming cavity of the molding tool that is closed.

5. The molding tool according to claim 4, wherein
the air channel component has a cuboidal shape,
the at least one groove includes a first groove and a second groove,
the first groove is formed in the surface to form the section of the non-design surface of the molding product,
the second groove is formed in a surface of the air channel component perpendicular to the surface to form the section of the non-design surface of the molding product, and
the second groove extends from one end of the surface adjacent to the air canal to another end of the surface connected to the first groove.

6. A method of producing a molding product using the molding tool according to claim 4, the method comprising:
injecting molten plastic into the forming cavity of the molding tool; and
blowing air into the air canal by the external air blower until a gap is created between the design surface and the second forming surface by a jet of air that reaches a boundary between the design surface and the second forming surface via the at least one groove and a gap between the non-design surface and the first forming surface created by the jet of air.

7. A method according to claim 6, further comprising:
applying a predefined pressure to the molten plastic in the forming cavity after the injecting of the molten plastic; and
cooling down the molten plastic in the forming cavity after the applying of the predefined pressure, wherein
the blowing of the air is started after completion of the applying of the predefined pressure and before completion of the cooling down of the molten plastic.

8. A method according to claim 7, wherein
the blowing of the air is started after the design surface is formed to an extent but before the molten plastic is completely solidified.
